(19) United States
(12) Patent Application Publication
(10) Pub. No.: US 2007/0225848 A1
(43) Pub. Date: Sep. 27, 2007

(54) Method and System for Providing Automatic and Accurate Manufacturing Delivery Schedule

(75) Inventors: Yung-Cheng Chang, Tainan (TW); Hsueh-Shih Fu, Hsin-Chu (TW); N. N. Fang, Yongkang City (TW)

Correspondence Address: HAYNES AND BOONE, LLP, 901 MAIN STREET, SUITE 3100, DALLAS, TX, 75202, US

(73) Assignee: TAIWAN SEMICONDUCTOR MANUFACTURING COMPANY, LTD., Hsin-Chu (TW)

(21) Appl. No.: 11/553,815

(22) Filed: Oct. 27, 2006

Related U.S. Application Data
(60) Provisional application No. 60/785,555, filed on Mar. 24, 2006.

(51) Int. Cl. G06F 19/00

(52) U.S. Cl. 700/101; 700/108

(57) ABSTRACT

Aspects of the present disclosure provide a method and a system for providing automatic and accurate manufacturing delivery schedule without human operations. The method and system receive a delivery schedule, monitor performance of at least one manufacturing process to produce a specific lot of a product based on a plurality of statistical process control rules, and automatically revise a priority of the specific lot of the product if a statistical process control rule is violated. By using statistical process control methods and rules to monitor lot production performance, lot priority may be automatically revised to assure on-time delivery.

### CROSS-REFERENCE

This patent claims the benefit of U.S. Ser. No. 60/785,555 filed Mar. 24, 2006, the contents of which are hereby incorporated by reference.

### BACKGROUND

The present disclosure relates in general to product manufacturing control, and in one embodiment, to a system and method for automatically and accurately providing a product delivery schedule for a semiconductor manufacturing facility.

In manufacturing industries such as a semiconductor fabrication facility (fab), the performance of a product is closely monitored. One performance index is the delivery schedule accuracy (DSA) index. The DSA index indicates how well a product production meets a customer demand. This index provides an indication of whether customers will receive their orders on time so as to minimize impact on their back-end production. Therefore, with an accurate DSA index, customer service satisfaction may improve. While the DSA index is well-defined, no systematic method currently exists that manages the index. In addition, coordinated human operations and people management in different manufacturing facilities are required to deliver a better DSA index. Such operations are error prone, and thus affect the accuracy of the index. Furthermore, no systematic method currently exists for handling DSA operations. Most manufacturing facilities rely on planners to manually provide and maintain DSA forecasts for the coming weeks. Even with a reliable forecast, the dynamic nature of the production environment may impact a predicted DSA index. In addition, human operations may not necessarily track the planner's forecasts. A need exists for a systematic method that provides a DSA index in an accurate and efficient manner. Furthermore, each facility may use its own method to manage the DSA index. Thus, a uniformed method is desirable for managing the index.

### BRIEF DESCRIPTION OF THE DRAWINGS

Aspects of the present disclosure are best understood from the following detailed description when read with the accompanying figures. It is emphasized that the figures and accompanying description are directed to different embodiments, or examples, that benefit from the present invention. The invention, of course, is defined by the claims provided at the end of the specification.

FIG. 1 illustrates a computer network environment in which one exemplary embodiment of a scheduling system can be implemented;

FIG. 2 is a diagram of an exemplary scheduling system and method according to one or more embodiments of the present invention;

FIG. 3 is a flow diagram of a further the scheduling system and method shown in FIG. 2, with additional detail provided for the sake of further example;

FIG. 4 is a flowchart of an exemplary embodiment of a method for use by the scheduling system described in FIGS. 2 and 3;

FIG. 5A is a flowchart of a method for monitoring performance of a specific lot of a product based on lot cycle time, according to one embodiment;

FIG. 5B is a flowchart of a method for monitoring performance of a specific lot of a product based on stage cycle time, according to one embodiment;

FIG. 6 is an exemplary graph of required cycle time vs. production dates for a single lot;

FIG. 7 is an exemplary graph of cycle times for all lots that are produced;

FIG. 8 is an exemplary graph of cycle time in a manufacturing stage required to produce a single lot; and

FIGS. 9A and 9B are diagrams of exemplary lot cycle times and corresponding probability regions, respectively.

### DETAILED DESCRIPTION

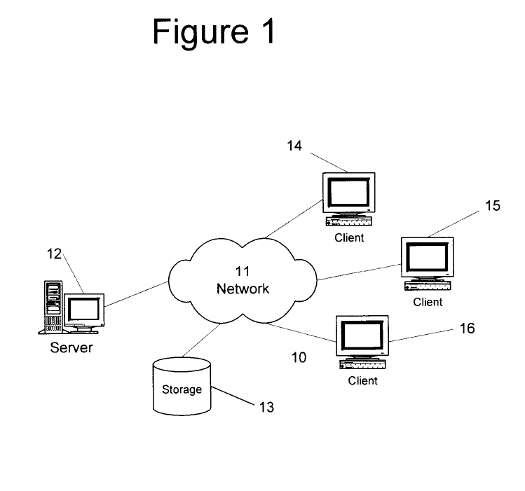

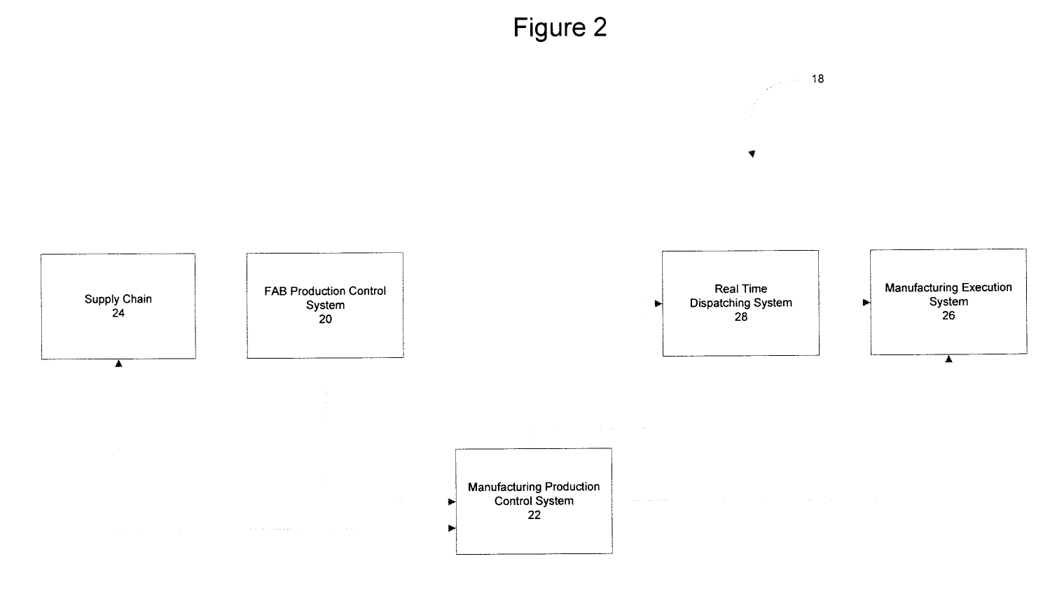

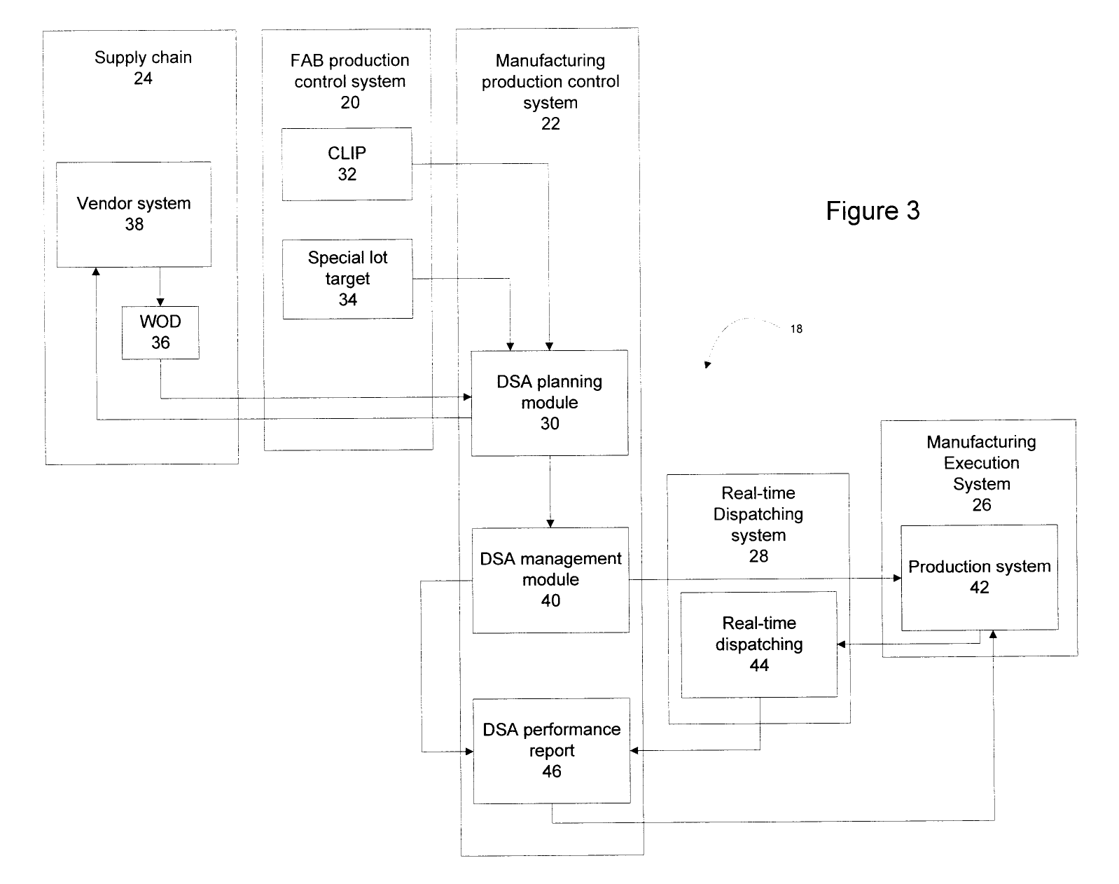

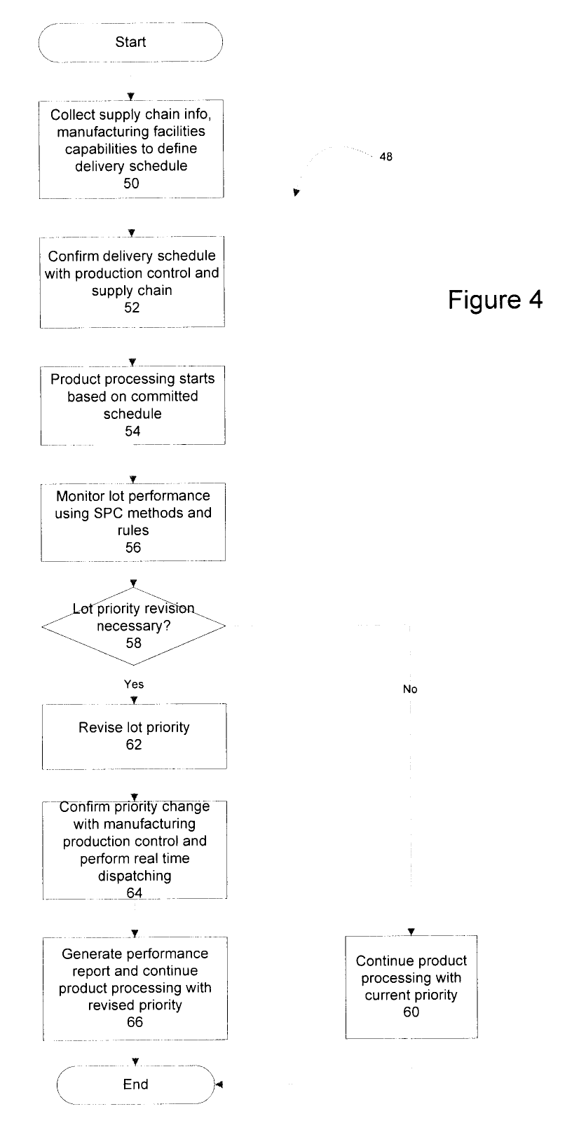

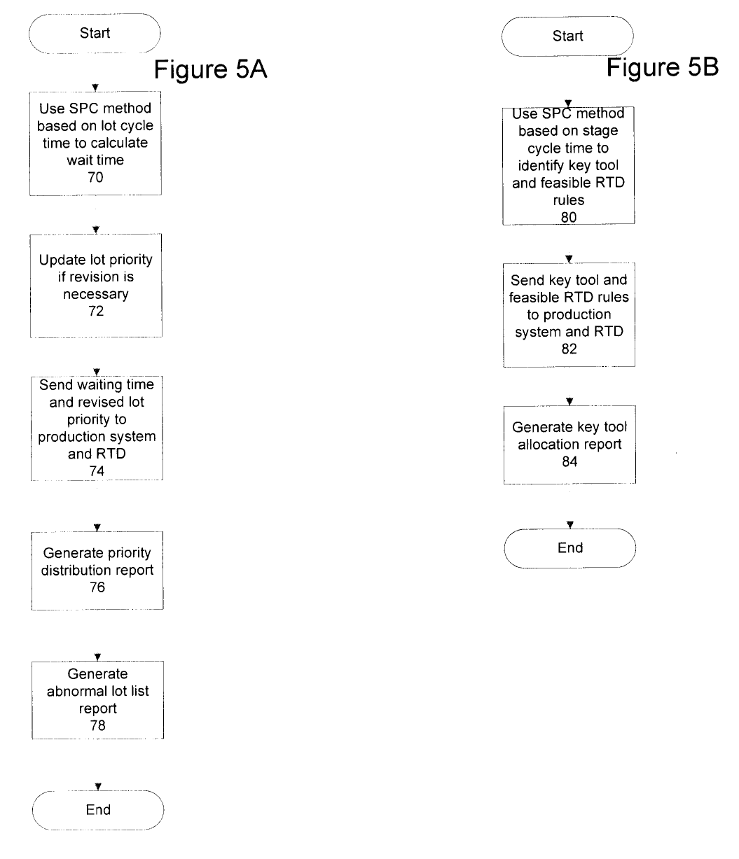

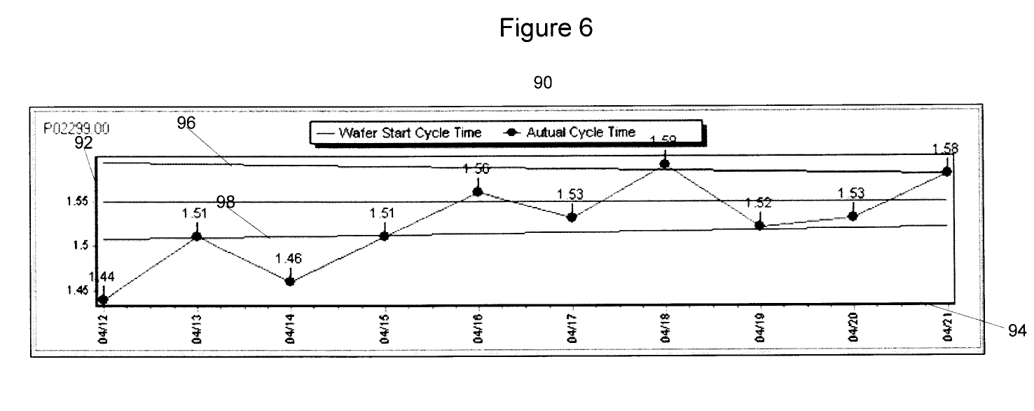

The present invention relates generally to a system and method for scheduling product handling. For the sake of example, reference will be made to several different embodiments of a scheduling system that are directed to automatically and accurately provide a schedule for delivering products from a manufacturing facility such as a semiconductor wafer fab. For the sake of further example, FIG. 1 will provide a computing and network environment in which one or more embodiments of the scheduling system, or components thereof, can be implemented. FIGS. 2-5B, and the corresponding discussion, will provide exemplary modules (FIGS. 2-3) and flow diagrams (FIGS. 4-5B) that can be used by the scheduling system of FIG. 1. FIGS. 6-9B describe exemplary operations of the scheduling system with corresponding, exemplary data.

Referring now to FIG. 1, a scheduling system according to at least one exemplary embodiment of the present invention can be implemented in a computing environment 10. The computing environment 10 includes a network 11, which provides a medium through which various devices and computers in the computing environment 10 can communicate. Network 11 may include connections such as wire, wireless, or fiber optic cables. Network 11 may include the Internet and/or a collection of networks and gateways that use such things as a Transmission Control Protocol/Internet Protocol (TCP/IP) suite of protocols to communicate with one another. In another example, the network 11 may include a number of different types of networks, such as a local area network (LAN), or a wide area network (WAN).

In the depicted example, a server 12, a storage unit 13, and clients 14, 15, and 16 are coupled to the network 11. Clients 14, 15, and 16 may be personal computers or other types of client devices, such as personal digital assistant (PDA), mobile telephones, and the like. In the depicted example, server 12 provides data and/or applications to the clients 14-16. Computing environment 10 may include additional nodes, such as additional servers, clients, and other devices not shown herein. FIG. 1 is intended as an example, and not as an architectural limitation for the present disclosure.

In a more specific example, scheduling system is used to control the operation of a semiconductor manufacturing facility, which fabricates groups of wafers arranged in lots. Each lot of wafers may be of a different design or technology, and proceeds to several different pieces of processing equipment in the facility. The lots typically accumulate between different pieces of equipment, and are processed according to a lot priority. In this example, the clients 14, 15, and 16 can be associated with entities such as product sales, customer purchasing, external delivery companies, material suppliers, process engineering, a production manager, lot movement systems, and/or one or more pieces of processing equipment.

Referring now to FIG. 2, in one embodiment, the scheduling system is designated with a reference numeral 18, and includes several modules, one or more of which can be implemented by computer software running on the server 12 and/or one or more of the clients 14, 15, and 16. The modules include a FAB production control system 20, a manufacturing production control (MPC) system 22, a supply chain 24, a manufacturing execution system (MES) 26, and a real-time dispatching (RTD) system 28. Each of the modules communicates with the manufacturing production control system 22. The FAB production control system 20 provides information relating to customer commitment to the manufacturing production control system 22. The supply chain 24 provides information relating to supplies needed for production to the manufacturing production control system 22.

The real-time dispatching system 28 receives lot priority information from the manufacturing production control system 22. In the semiconductor wafer manufacturing example, priority can be given to certain wafer lots being processed. During production, the manufacturing production control system 22 monitors the progress and revises the priority of product if necessary. If the priority is revised, the manufacturing production control system 22 sends instructions to the real time dispatching system 28 to dispatch tools necessary for production. The manufacturing execution system 26 receives information from the real-time dispatching system 28 for performing the production processes accordingly. The manufacturing production control system 22 also confirms the delivery schedule with the supply chain 24 once it is defined and instructs the manufacturing execution system 26 to begin product processing according to the confirmed delivery schedule. In addition, the manufacturing production control system 22 provides reports of performance to the manufacturing execution system 26 during product processing. Examples and operation of each of the modules is described in further detail below.

Referring now to FIG. 3, a more detailed example of the scheduling system 18 is described. The manufacturing production control system 22 includes a delivery schedule accuracy (DSA) planning module 30. The DSA planning module 30 collects relevant information from the FAB production control system 20 to define delivery lots for a predetermined time period in the future, such as a number of weeks. Among the relevant information, the DSA planning module 30 collects a committed line item performance (CLIP) 32 and a special lot target 34. The CLIP 32 includes a stated commitment to a customer for delivery of a certain number of products before a given date. The special lot target 34 may include other commitment lot information, such as the number of lots a manufacturing facility may produce and other manufacturing control information.

In addition, the DSA planning module 30 defines a lot delivery schedule for the predetermined period of time in the future by evaluating information from supply chain 24. In the present example, a wafer-out-date (WOD) 36 is received by the DSA planning module 30 from a vendor system 38 of the supply chain 24. The wafer-out-date 36 is a date of delivery that is specified by the customer. The vendor system 38 is a third party system that stores customer delivery information.

Once the lot delivery schedule is defined, the DSA planning module 30 confirms the schedule with the manufacturing production control system 22. The DSA planning module 30 also confirms the committed schedule with the vendor system 38 of the supply chain 24. Once the schedule is confirmed, the manufacturing execution system 26 starts product processing based on the committed schedule.

The manufacturing production control system also includes a DSA management module 40. During product processing, the DSA management module 40 monitors the progression and/or performance of each lot of the product using statistical process control (SPC) methods and rules (generically referred to as “rules”). More details regarding monitoring performance of each lot using statistical process control rules are described below with reference to FIG. 4. If the performance of a lot violates a statistical process control rule, the DSA management module 40 performs priority operations to automatically revise a lot priority. An example of a violation of a statistical process control rule is when discrepancies exist between the planned lot data and the actual lot data. A revised priority is then confirmed with the manufacturing production control system 22 and a lot priority is revised in a production system 42 which controls processing equipment operations. The production system 42 is part of the manufacturing execution system 26.

In an illustrative embodiment, the DSA management module 40 may downgrade the priority if the lot cycle time is too fast, or upgrade the lot priority if the lot cycle time is too slow. If a lot priority is revised, the real-time dispatching system 28 receives the revised lot priority in a real time dispatching module 44, which dispatches the tools necessary for production. Subsequently, a DSA performance report 46 is generated by DSA management module 40 to provide feedback to production system 42. DSA performance report 46 includes information of abnormal priority change and overall performance data. By following the revised priority for operation, the likelihood an on-time delivery to the customer is increased.

Referring now to FIGS. 3 and 4, operation of the scheduling system 18 can be further described by a scheduling method 48. The scheduling method 48 provides one exemplary embodiment, it being understood that other methods may also be performed by the scheduling system. In the present embodiment, the method begins at step 50 where the DSA planning module 30 collects supply chain information and manufacturing facility capabilities to define a delivery schedule. Supply chain information may be collected from the vendor system 38 and manufacturing facility capabilities may be collected from the manufacturing process control system 22. Next, the method proceeds to step 52 to confirm the defined delivery schedule with the manufacturing production control system 22 and the vendor system 38 of supply chain 24.

Once the manufacturing production control system 22 and the vendor system 38 confirm the committed delivery schedule, the method proceeds to step 54, where the manufacturing execution system 26 starts or continues product processing based on the committed delivery schedule. During product processing, the method proceeds to step 56, where the DSA management module 40 monitors the performance of each lot of the product using statistical process control rules. More details regarding step 56 are described below with reference to FIGS. 5A-5B. The method then proceeds to step 58, where a determination is made by the DSA management module 40 as to whether a lot priority revision is necessary. This determination may be made based on whether discrepancies exist between planned lot data and actual lot data collected during processing of the product. If a lot priority revision is not necessary, the method proceeds to step 60, where the manufacturing execution system 26 continues processing the product with the current priority.

However, if a lot priority revision is necessary, the method proceeds to step 62, where the DSA management module 40 performs priority operations to revise the lot priority. The priority operations can consider various data received from other modules, as well as the priority of other lots in production. The method then proceeds to step 64, where the DSA management module 40 confirms a change of priority with the manufacturing production control system 22 and sends instructions to real-time dispatching system 28 to perform real time dispatching. Finally, the method proceeds to step 66, where the DSA management module 40 generates a DSA performance report 46 and continues product processing with the revised lot priority.

FIG. 5A is a flowchart of an exemplary method for monitoring performance of a specific lot of a product based on lot cycle time. The method may be performed by the DSA management module 40. As shown in FIG. 5A, the method begins at step 70, where the DSA management module 40 utilizes a statistical process control method based on lot cycle time to calculate a waiting time.

Next, the method proceeds to step 72, where the DSA management module 70 updates the lot priority automatically if a lot priority revision is necessary. The method then proceeds to step 74, where the DSA management module 40 sends the calculated wait time and revised lot priority to production system 42 and real-time dispatching system 28 for dispatching. If the lot priority is revised, the method then proceeds to step 76, where the DSA management module 40 generates a priority distribution report to identify the lot priority distribution. The method then proceeds to step 78, where the DSA management module 40 generates an abnormal lot list report to illustrate a list of abnormal lots. Thereafter, the method terminates.

In addition to lot cycle time, the DSA management module 40 may utilize a statistical process control method based on stage cycle time. FIG. 5B is a flowchart of a method for monitoring performance of a specific product based on stage cycle time. This exemplary method may be performed by the DSA management module 40. As shown in FIG. 5B, the method begins at step 80, where the DSA management module 40 utilizes a statistical process control method based on stage cycle time to identify key tools and feasible real-time dispatching rules. Next, the method proceeds to step 82, where the DSA management module 40 sends the identified key tools and feasible real-time dispatching rules to production system 42 and real-time dispatching system 28 for real time tool dispatching. The method then proceeds to step 84, where the DSA management module 40 generates a key tool allocation report to illustrate tool allocations.

As described above, one statistical process control rule utilized by the system to determine a need for a revised lot priority is based on a lot cycle time. Lot cycle time measures the time required to produce a single lot of a product. FIG. 6 provides an exemplary graph 90 of required cycle time vs. production dates for a single lot. The graph 90 includes a Y-axis 92 indicating required cycle times of a single lot and an X-axis 94 indicating production dates of the lot. In graph 90, an upper boundary 96 and a lower boundary 98 are defined to limit required cycle time to a range that is acceptable. In this example, for production date April 14, a mean target cycle time of 1.46 is measured, which is outside of the upper and lower boundaries of the required cycle time. This indicates that the mean target cycle time is below an acceptable cycle time. Therefore, lot priority may need to be revised in order to meet the delivery schedule.

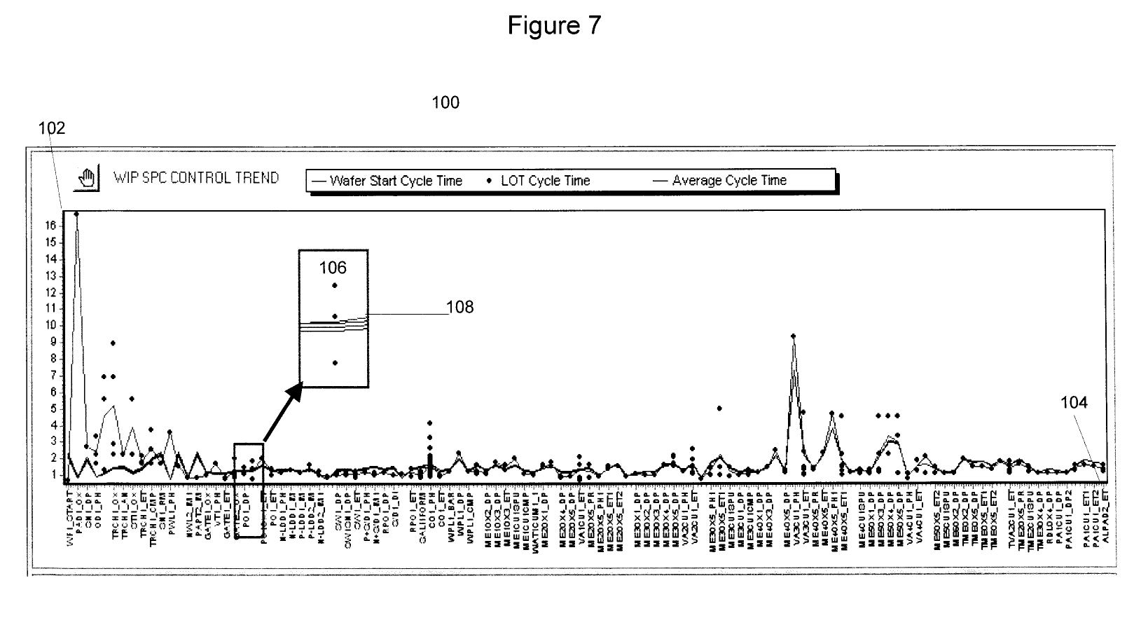

FIG. 7 provides an exemplary graph 100 of cycle times for all lots that are produced. The graph 100 includes a Y-axis 102 indicating cycle times of all lots and an X-axis 104 indicating names of the lots. As shown in an enlarged area 106 of the graph, cycle time of each lot, represented by the dots, are compared to an average cycle time 108 of all lots to determine whether lot priority revisions are necessary.

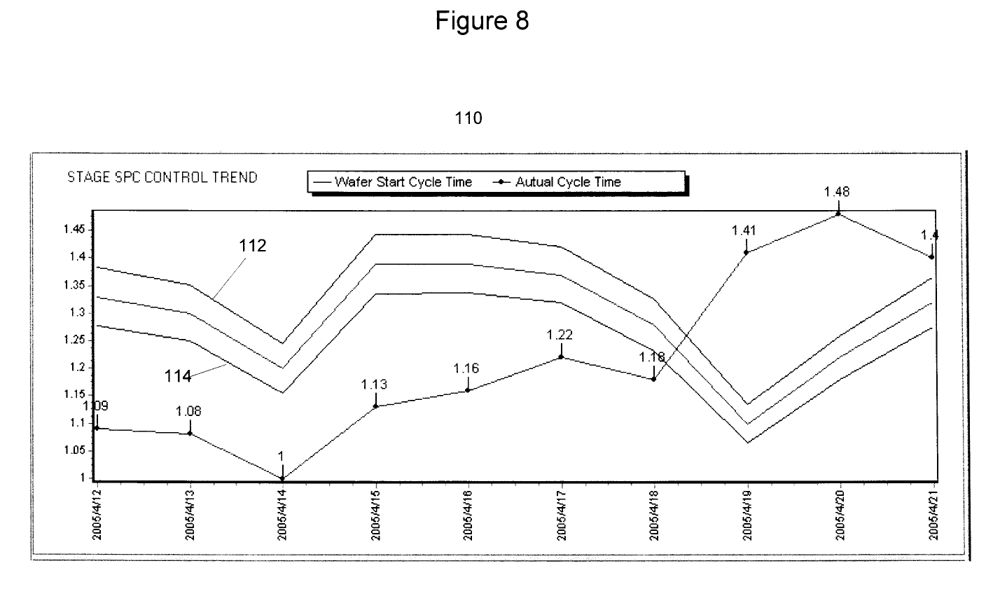

In addition to using lot cycle time to determine the need for revising lot priority, another statistical process control rule utilized by the system can be based on a stage cycle time. Stage cycle time measures the time required at each manufacturing stage to produce a single lot. FIG. 8 provides an exemplary graph 110 of cycle time in a manufacturing stage required to produce a single lot. As shown in FIG. 8, graph 110 includes an upper boundary 112 and a lower boundary 114. A mean cycle time of a lot in a manufacturing stage is compared against the upper 112 and lower 114 boundaries in the manufacturing stage to determine whether the lot priority needs to be revised in order to meet the delivery schedule. Based on the cycle time in a manufacturing stage, suggestions can be made by the DSA management module 40 to suggest an on/off list of tools, as well as key tools to use in the future and the productivity history of the key tools.

As described above, statistical process control methods based on lot cycle time and/or stage cycle time may be utilized to determine whether the performance of the lot violates statistical process control rules. Based on the results, the DSA management module 40 may determine what corrective actions to take to optimize the lot priority. For example, a probability of SPC rule violation may be determined based on the lot cycle time deviation. Lots may then be grouped based on the probability of SPC rule violation to identify necessary corrective actions.

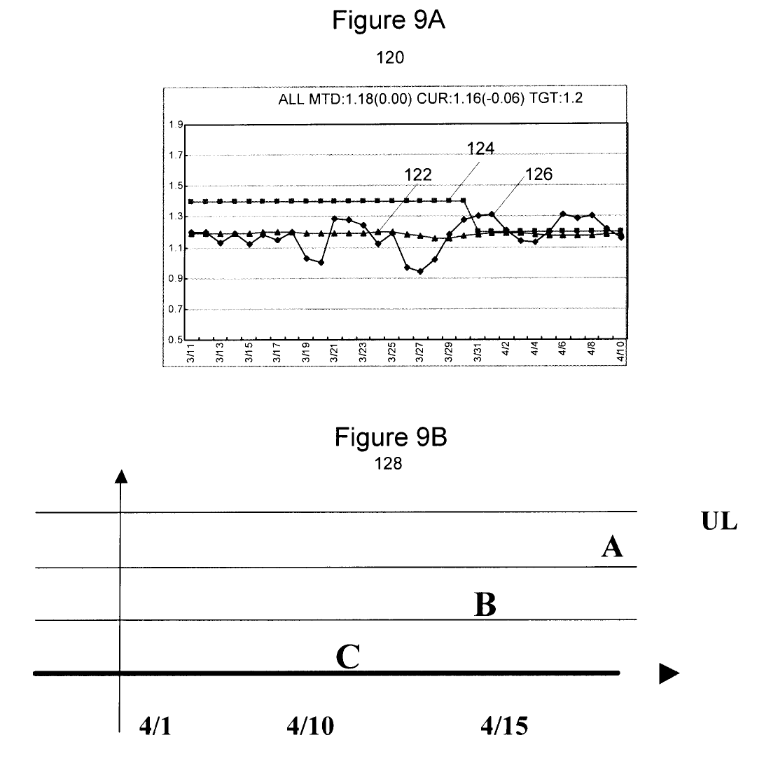

FIGS. 9A and 9B are diagrams of exemplary lot cycle times and corresponding probability regions. As shown in FIG. 9A, a graph 120 shows a distribution of lot cycle time for three different lots, lots 122, 124, and 126. In order to determine a probability of SPC rule violation, probability regions are identified in a graph 128 in FIG. 9B. There are three probability regions: A, B, and C. In this example, lots having one data point outside of boundary, UL, two or three data points in region A, four or five data points in region A or B, or eight consecutive data points above the median are considered abnormal, because the probability of SPC rule violation for these lots is less than or equal to 10 percent. This means that these lots have a slight chance of SPU rule violation. Therefore, no corrective action is required.

However, for lots having five consecutive data points in region A, a corrective action may be required since the probability of SPU rule violation for these lots is between 10 to 60 percent. For lots having six or seven consecutive data points in region A, an action is required since the probability of SPC rule violation for these lots is greater than or equal to 60 percent, which means that these lots have a higher chance of violating the SPC rule.

An example of corrective actions that may be taken includes auto-recovery actions. One examples of auto-recovery actions includes upgrading lot priority for lots having five consecutive data points in region A. In addition, other auto-recovery actions include upgrading lot priority, calculating a feasible waiting time for real time delivery to postpone dispatching, delaying delivery of the lots, and notifying monitoring engineer of all recovery actions that may be taken for lots having six or seven data points in region A.

In addition to a distribution of lot cycle time deviation, the overall cycle time of the lots may also be used to identify necessary corrective actions. For example, for lots having five data points in region A, an alarm message may be sent to the manufacturing production control system 22. For lots having six or seven consecutive data points in region A, an alarm message may be sent to the manufacturing production control system 22, target cycle time may be revised, and target cycle to the vendor system 38 may be submitted to re-plan the wafer-out-date.

In summary, the aspects of the present disclosure provide a method and system for providing automatic and accurate manufacturing delivery schedule without human operations. By using statistical process control methods and rules to monitor lot production performance, lot priority may be automatically revised to assure on-time delivery. In this way, customer service satisfaction may be improved.

The present disclosure can take the form of an entirely hardware embodiment, an entirely software embodiment, or an embodiment containing both hardware and software elements. In an illustrative embodiment, the disclosure is implemented in software, which includes but is not limited to firmware, resident software, microcode, etc.

Furthermore, embodiments of the present disclosure can take the form of a computer program product accessible from a tangible computer-usable or computer-readable medium providing program code for use by or in connection with a computer or any instruction execution system. For the purposes of this description, a tangible computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, a semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and digital video disc (DVD).

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method for scheduling product delivery in a manufacturing environment including a plurality of manufacturing processes, the method comprising:
receiving a delivery schedule;
determining a priority for a product based on the delivery schedule;
dispatching the product with the determined priority to a manufacturing production system;
repeatedly monitoring a performance of at least one manufacturing process based on at least one statistical process control rule; and
automatically revising the priority of the product if the at least one statistical process control rule is violated.

2. The method of claim 1, wherein the delivery schedule is received from a manufacturing facility process control system.

3. The method of claim 1, wherein the delivery schedule is received from a supply chain.

4. The method of claim 2, wherein receiving a delivery schedule comprises:
receiving a requested number of products from a customer and product information from the manufacturing facility process control system;
receiving a delivery date specified by the customer from a vendor system of the supply chain; and
determining a delivery schedule from the requested number of products, product information, and delivery date.

5. The method of claim 1, wherein the at least one statistical process control rule is based on a lot cycle time and further comprises:
comparing a required cycle time of a specific lot of the product against an upper boundary and a lower boundary; and
determining if the required cycle time is outside of the upper boundary and the lower boundary.

6. The method of claim 5, wherein automatically revising a priority comprises:
automatically revising the priority of a specific lot of the product if the required cycle time is outside of the upper boundary and the lower boundary; and
sending a revised priority to the manufacturing production system.

7. The method of claim 1, wherein the at least one statistical process control rule is based on a lot cycle time and further comprises:
comparing a required cycle time of a specific lot of the product against an average cycle time of all lots of the product; and
determining if the required cycle time is below the average cycle time.

8. The method of claim 7, wherein automatically revising a priority comprises:
automatically revising the priority of the specific lot of the product if the required cycle time is below the average cycle time; and
sending a revised priority to a manufacturing production system.

9. The method of claim 1, wherein automatically revising a priority comprises:
automatically upgrading the priority of a specific lot of the product if the required cycle time is too slow; and
automatically downgrading the priority of the specific lot of the product if the required cycle time is too fast.

10. The method of claim 1 further comprising:
confirming a revision of the priority with the manufacturing production system;
continuing the at least one manufacturing process to produce the product based on a revised priority; and
dispatching in real-time.

11. The method of claim 1, wherein the at least one statistical process control rule is based on a stage cycle time and further comprises:
comparing a required cycle time of a specific lot of the product in a manufacturing stage against an upper boundary and a lower boundary in the manufacturing stage; and
determining if the required cycle time is outside of the upper boundary and the lower boundary.

12. The method of claim 11, further comprising:
identifying at least one key tool;
identifying at least one feasible real-time dispatching rule; and
sending the at least one key tool and the at least one feasible real-time dispatching rule to the manufacturing production system.

13. The method of claim 12, further comprising:
generating a key tool allocation report based on the at least one key tool.

14. A system for providing automatic delivery schedule accuracy in a facility for fabricating semiconductor products grouped in lots, the system comprising:
a planning module operable to receive a delivery schedule; and
a management module operable to monitor performance of at least one manufacturing process to produce a specific lot of a product based on a plurality of statistical process control rules, and to automatically revise a priority of the specific lot of the product if a statistical control process rule is violated, wherein the at least one manufacturing process is determinative of the delivery schedule.

15. The system of claim 14, wherein the management module is further operable to monitor the performance of the at least one manufacturing process by performing statistical process control based on at least one of a lot cycle time and a stage cycle time.

16. The system of claim 15, wherein the statistical process control rule is based on a lot cycle time and is configured for:
comparing a required cycle time of the specific lot of the product against an upper boundary and a lower boundary; and
determining if the required cycle time is outside of the upper boundary and the lower boundary.

17. The system of claim 15, wherein the statistical process control rule is based on a stage cycle time and is configured for:
comparing a required cycle time of the specific lot of the product in a manufacturing stage against an upper boundary and a lower boundary of all lots of the product in the manufacturing stage; and
determining if the required cycle time is outside of the upper boundary and the lower boundary.

18. The system of claim 14, wherein the management module is configured to:
automatically upgrade the priority of the specific lot of the product if the required cycle time is too slow; and
automatically downgrade the priority of the specific lot of the product if the required cycle time is too fast.

19. The system of claim 15, wherein the statistical process control rule is based on a lot cycle time and is configured for:
comparing a required cycle time of the specific lot of the product against an average cycle time of all lots of the product; and
determining if the required cycle time is below the average cycle time.

20. A computer implemented scheduling system for use in a facility for fabricating semiconductor products arranged in lots, the scheduling system comprising:
a production control system;
a supply chain;
a production control system;
a real-time dispatching system; and
a manufacturing execution system;
wherein the production control system is configured to collect commitment information from the production control system and supply information from the supply chain;
wherein the production control system is configured to define a lot priority based on the commitment information and the supply information, and provide the lot priority to the real-time dispatching system;
wherein the real-time dispatching system is configured to schedule product lots for fabrication according to the lot priority; and
wherein the production control system is configured to monitor the progression of each lot of the product using a statistical process control rule, such that if the performance of a lot violates the statistical process control rule, the production control system automatically revises the lot priority and provides the revised lot priority to the real-time dispatching system.
